(19) United States
(12) Patent Application Publication
(10) Pub. No.: US 2026/0110555 A1
(43) Pub. Date: Apr. 23, 2026

(54) METHOD FOR MEASURING THE IMPEDANCE OF ELECTRICAL COMPONENTS

(71) Applicant: ELMOS Semiconductor SE, Dortmund (DE)

(72) Inventors: Rolf MELCHER, Gummersbach (DE); Thomas FRANK, Graden-Neudorf (DE)

(73) Assignee: ELMOS Semiconductor SE, Dortmund (DE)

(21) Appl. No.: 19/117,040

(22) PCT Filed: Oct. 9, 2023
(86) PCT No.: PCT/EP2023/077898

§ 371 Date: Mar. 29, 2025

(30) Foreign Application Priority Data
Oct. 10, 2022 (DE) 10 2022 126 107.7

(51) Int. Cl. G01D 5/24

(52) U.S. Cl. CPC G01D 5/24

(57) ABSTRACT

A method is disclosed for determining an electrical signal characteristic indicative of the magnitude of and/or change in an impedance that varies in response to a magnetic, electric, or electromagnetic field affected by an approaching object. The method includes performing measurements over at least one group of measurement intervals, each group preceded by at least one compensation interval. A sinusoidal excitation voltage is applied to the impedance during each interval, inducing a measuring current. A compensation current is determined during the compensation interval and subtracted from the measuring current of at least one subsequent measurement interval to generate an analog evaluation current. The evaluation current serves as a signal representative of the impedance's magnitude and/or change in the impedance.

### CROSS REFERENCE TO RELATED APPLICATIONS

This Application is a National Phase of, and claims priority to, International Application Number PCT/EP2023/077898, filed Oct. 9, 2023, which claims priority to German patent application 10 2022 126 107.7 dated Oct. 10, 2022, the entire disclosures of each of which are incorporated herein by reference.

### TECHNICAL FIELD

The present disclosure relates to electrical measurement systems and methods, and more specifically to techniques for measuring the impedance of electrical components. In particular, the disclosure concerns improved methods for repeatedly determining an electrical signal characteristic of the magnitude and/or variation of impedance that changes under the influence of magnetic, electric, or electromagnetic fields—such as in applications involving capacitive or inductive sensors. This technology is, e.g., relevant for use in automotive systems, including steering wheel grip detection and seat occupancy monitoring, where high-resolution impedance measurement is beneficial despite system-inherent offset signals and limited analog-to-digital converter (ADC) resolution.

### BACKGROUND

Modern electronic systems increasingly rely on accurate and high-resolution impedance measurements to detect environmental or situational changes. In automotive applications, for instance, systems may use changes in impedance to detect whether a driver is gripping the steering wheel or whether a passenger is occupying a seat. These systems typically rely on sensors that measure capacitive or inductive variations caused by the proximity or presence of a human body or object.

However, accurately measuring such impedance changes presents significant challenges. In practical implementations, the measurement signals often include offset components due to factors such as electromagnetic compatibility (EMC) filters or external interferences. These offsets can significantly exceed the useful signal levels, making it difficult to achieve accurate results with standard analog-to-digital converters (ADCs), which are often limited in resolution and input voltage range.

Conventional approaches attempt to address this issue by using high-resolution ADCs with wide input ranges, but such solutions are costly, consume more power, and increase system complexity. Furthermore, existing methods do not sufficiently compensate for offset signals in real time, leading to degraded measurement accuracy, especially in dynamic environments where impedance values fluctuate over time.

Accordingly, there is a need for an improved method of measuring impedance that allows the use of standard ADCs while maintaining high resolution and accuracy. Such a method may compensate for offset signals, reduce the magnitude of processed signals, and adapt dynamically to changing measurement conditions without requiring excessive hardware complexity.

The disclosure relates to a method for measuring the impedance of electrical components and in particular to a method for determining, at multiple intervals and thus repeatedly, an electrical signal characteristic of the magnitude of and/or the change in an impedance, wherein the impedance may change e.g. under the influence of a magnetic, electric and/or electromagnetic field which, for its part, may change due to an object approaching the impedance.

Depending on the application, the repeated determination of the impedance of electrical components installed in a vehicle is of great importance. Examples include the detection of the driver's hand gripping the steering wheel or seat occupancy detection.

Due to various influencing factors or compensation measures, the measurement signals used for impedance measurement are not free of offsets. For example, externally connected EMC filters lead to such offsets.

The offset signal component can sometimes be significantly larger than the useful signal component. For this reason, analog-to-digital converters (ADC) with a comparatively high resolution and number of bits as well as a high permissible input voltage are typically used for digital processing of the measurement signal, but this means substantial effort and is therefore disadvantageous. If the maximum resolution of the ADCs used is limited, the resolution of the measurement signal is also severely limited, which is particularly disadvantageous with comparatively large signals.

A method for measuring the impedance of electrical components is known from US-A-2021/0081073. According to this method, the measurement signal is amplified using a transimpedance amplifier, which means that comparatively large measurement signals are processed. However, this entails the risk that the analog-to-digital converters used for the digital processing of the measurement signal should have a comparatively high resolution and number of bits as well as a high permissible input voltage, which is associated with the correspondingly high effort described above.

U.S. Pat. No. 9,575,105 describes a method and a device for measuring complex impedances.

Finally, DE-A-10 2013 227 225 shows a current-based charge compensation in a touch sensor that works capacitively.

### SUMMARY

It is an object of the disclosure to provide a method of the type mentioned above, with which the signals representing the impedance can be kept low without impairing the accuracy of the measurement.

To achieve this object, the disclosure proposes, in a first variant, a method for determining, at multiple intervals and thus repeatedly, an electrical signal characteristic of the magnitude of and/or the change in an impedance which changes under the influence of a magnetic, electric and/or electromagnetic field which for its part changes due to an object approaching the impedance, wherein in the method the intervals comprise at least one group of measurement intervals, which has one or more consecutive measurement intervals, and at least one compensation interval positioned chronologically before the at least one group or before each group of measurement intervals, per measurement interval a sinusoidal excitation voltage is applied to the impedance and a measuring current is induced in the impedance as a result of the excitation voltage, the measurement current of a compensation interval is used as a compensation current for at least one subsequent measurement interval by subtracting the compensation current in the at least one subsequent measurement interval from the measurement current of this measurement interval to form an analogue evaluation current signal. The evaluation current signal is the signal that is characteristic of the magnitude of and/or the change in the impedance.

According to the disclosure, the determination is performed in intervals which comprise at least one group of measurement intervals, which group has one or more consecutive measurement intervals and at least one compensation interval positioned chronologically before the at least one group or before each group of measurement intervals. In all of these intervals (measurement intervals and compensation intervals), a measurement current is detected which is induced by the impedance as a result of an excitation voltage with which it is excited sinusoidally. The measurement current of a compensation interval is used as a compensation current in at least one of the subsequent measurement intervals by subtracting it in the at least one subsequent measurement interval from the measurement current obtained in this measurement interval to form an analog evaluation current signal. The evaluation current signal is now characteristic of the magnitude of and/or the change in the impedance.

By the approach according to the disclosure of only recording the changes in impedance from interval to interval, the electrical current signals are kept “small”. High resolution can be used for further processing, even if, for example, ADCs are used for digital signal processing purposes whose resolution (i.e. number of bits) and permissible input voltage range are limited.

According to the disclosure, it is advantageous if the analog evaluation current signal is amplified, and that the evaluation current signal amplified in this way is the signal characteristic of the magnitude and/or the change in impedance. Here, too, there are no significant restrictions when converting the amplified analog evaluation current signal into a digital signal if the amplified analog evaluation current signal does not (yet) lead to the ADC being exceeded. If necessary, the amplification factor of the amplifier can be automatically and dynamically adjusted accordingly so that the amplified signal has the maximum permissible value to avoid overloading the ADC, regardless of the size of the analog evaluation current signal at the input of the amplifier.

In a further example of the disclosure, it may be provided that the compensation current is generated by a signal generation unit after it has been determined, in order to be subtracted from the measurement current of the at least one measurement interval.

Compensation intervals can be placed between and within groups of measurement intervals in a variety of ways. For example, a (single) compensation interval could be provided at the beginning of the procedure, which provides the compensation current for the subsequent measurement intervals, which can be subtracted from the respective measurement current measured in each subsequent measurement interval. However, if it is to be feared that the compensation current is no longer adapted well enough in the course of the intermittent impedance measurement to lead to a sufficiently small analog evaluation current signal after subtraction from the respective measurement current, it is advantageous to carry out a compensation interval again once the overload or overdrive limit of the ADC has been exceeded in order to obtain a comparatively small analog evaluation current signal for the next measurement intervals. If the evaluation current signal is amplified before the analog-to-digital conversion, which is typically the case, the condition for a new determination of the compensation current could be the exceeding of a specified maximum permissible value of the evaluation current signal at the input of the amplifier or, if an amplifier with an amplification factor that automatically adapts to the size of the input signal is used, falling below a specified minimum permissible amplification factor.

As already mentioned above, the aim of the disclosure is to be able to continue working with comparatively small analog evaluation current signals, in order to be able to continue working with ADCs that are limited in their resolution and their maximum permissible analog input voltage and still have a sufficiently high resolution after amplification has typically taken place, provided that further signal processing is digital, which will be discussed further below.

In a further advantageous example of the disclosure, it can be advantageous if the possibly amplified analog evaluation current signal is subjected to an I-Q demodulation after an analog-to-digital conversion, the I signal component and/or the Q signal component of the I-Q demodulation being the signal characteristic of the magnitude and/or the change in impedance. In this example of the disclosure, use is made of digital I-Q demodulation, the I and Q amplitudes of which provide the values characteristic of the magnitude and/or the change in impedance. In this further development of the disclosure, the compensation current can now be generated using the parameters of the digital I-Q demodulation of the chronologically last compensation interval. In this case, the compensation current is also generated digitally, whereupon the compensation current generated in this way is converted by a digital-to-analog converter (DAC) into an analog compensation current, which is then subtracted from the measuring current of the respective measuring interval.

Digital signal processing in the form of digital I-Q demodulation offers a number of advantages. However, the maximum resolution that can be achieved during digital processing of the signals is limited due to the finite input voltage of the ADC. If, for example, an offset increases the measured values, the maximum achievable resolution is reduced accordingly. Therefore, currents which are connected in parallel to the variable impedance to be measured should be compensated. According to the disclosure, this is done by subtracting the compensation currents from the actual measuring currents so that the analog evaluation current signals are as small as possible. After a possibly performed signal amplification, a high resolution of the measured value for digital signal processing is obtained despite the limited resolution of the ADC. The amplitude of the analog evaluation current can then even be amplified before processing takes place in the ADC. For sinusoidal excitation signals, which are advantageously used in the context of the disclosure, the offset signal can be generated as the sum of the scaled I-Q demodulation signals and fed back for subtraction using a current DAC, for example.

When using analog demodulation, the achievable signal resolution can be increased by subtracting a DC offset after demodulation and then amplifying the signal before feeding it into an ADC. This is not possible with digital demodulation, as is provided in an advantageous further development of the disclosure, since an alternating signal is present at the ADC and this signal cannot be compensated with a DC offset.

The compensation method according to the disclosure, which advantageously includes digital demodulation, allows the evaluation current signal to be amplified to a higher level without exceeding the (limited) input voltage range of the ADC. As with analog demodulation, this makes it possible to increase the resolution.

According to an advantageous example of the disclosure, it is provided that the compensation current is calculated by means of a preferably computer-implemented neural network model of any type and any structure as known in principle from the prior art, and/or a preferably computer-implemented hidden Markov model and/or a Petri net and/or automatic learning of any kind for generating knowledge from the past and previous experiences, such as preferably computer-implemented machine learning, preferably computer-implemented deep learning and/or a preferably computer-implemented processing of predictors, i.e. predictive variables from events registered in the past, wherein the execution code for executing the respective methods is preferably stored in a memory and preferably executed by a processor (computer implementation).

According to a variant of the above object, a method is proposed for determining, at multiple intervals and thus repeatedly, an electrical signal characteristic of the magnitude of and/or the change in an impedance which changes under the influence of a magnetic, electric and/or electromagnetic field which for its part changes due to an object approaching the impedance, wherein in the method per interval a sinusoidal excitation voltage is applied to the impedance and a measuring current is induced in the impedance as a result of the excitation voltage, the difference between the measuring current and a compensation current is fed to the input of an analog or digital integrator, the output of which supplies the compensation current after digital-to-analog conversion, if necessary, and the output of the integrator (42) forms the signal characteristic of the magnitude and/or change in impedance.

In this second variant of the disclosure, a feedback system is used to form the compensation current, which is subtracted from the measuring current. Each interval is therefore in this respect a measuring interval in the above-mentioned sense of the first variant of the disclosure. An error or delta integrator, which reacts to changes in the measurement signal, integrates the difference between the compensation current and the measuring current. In the stationary case, the delta integrator then provides a constant signal at its output, which indicates that the impedance does not change. If it changes, a change in its signal is generated at the output of the integrator, which in turn is fed back as a changed compensation current and thus also shows the change in impedance.

This second variant of the disclosure also works with the smallest possible signals, which in turn brings with it the advantage already mentioned above, namely that conventional ADCs with limited resolution and limited permissible input voltage range can be used to convert the analog measurement signals into digital signals (whereby these small analog measurement signals can then still be amplified) without having to forego the high resolution desired for the evaluation of the measuring currents.

In a further example of the disclosure according to its second variant, it can be provided that the differential signal from the difference between the measuring current and the compensation current is subjected to an analog-to-digital conversion, if necessary after amplification, and is then fed to a digital I-Q demodulator, whose I and Q signal components are fed to the input of a digital integrator, and that to form the compensation current, the I and Q signal components integrated over time are modulated in a digital I-Q modulator whose output is connected to a digital-to-analog converter that outputs the compensation current.

According to a third variant of the disclosure, the above object is achieved with a method for determining, at multiple intervals and thus repeatedly, an electrical signal characteristic of the magnitude of and/or the change in an impedance which changes under the influence of a magnetic, electric and/or electromagnetic field which for its part changes due to an object approaching the impedance, wherein in the method per interval a sinusoidal excitation voltage is applied to the impedance, a measuring current is induced in the impedance as a result of the excitation voltage, a reference impedance of known magnitude is subjected to a compensation voltage that is 180° out of phase with the excitation voltage, and a compensation current is induced in the reference impedance as a result of the compensation voltage, the difference between the measuring current and the compensation current is fed to the input of an analog or digital integrator, the output of which provides the magnitude of the compensation current after digital-to-analog conversion, if necessary, the compensation voltage is generated and the output of the integrator (42) is the signal characteristic of the magnitude and/or the change in impedance.

In this third variant of the disclosure, a reference impedance is used to determine the size of the impedance. The reference impedance is excited with a compensation voltage and then induces a compensation current which is subtracted from the measuring current induced as a result of the excitation voltage for the impedance to be measured. The differential signal is fed to a digital delta integrator, which integrates the difference and determines the compensation voltage at its output, which in turn is used to excite the reference impedance. The magnitude of the compensation voltage is characteristic of the magnitude of the impedance and/or its change.

Instead of one reference impedance, several reference impedances of different sizes can also be selected, depending on the size of the impedance to be measured. In this way, the differential signal is minimal, which in turn leads to the above-mentioned advantages with regard to the high resolution in the digital section despite the limited number of bits and input voltage of the ADC.

The different reference impedances can optionally be controlled via a multiplexer. Alternatively, the size of the reference impedance can also be adjusted. The use of a superimposed control loop with the aim of standardizing the measurement result to 1 is also expedient here.

In a further example of the disclosure, it can be provided that the differential signal from the difference between the measuring current and the compensation current is subjected to an analog-to-digital conversion, if necessary after amplification, and is then fed to a digital I-Q demodulator, whose I and Q signal components are fed to the input of a digital integrator, and that to form the compensation voltage, the I and Q signal components integrated over time are modulated in a digital I-Q modulator whose output is connected to a digital-to-analog converter that outputs the compensation voltage.

The impedance to be measured is in particular a capacitively operating seat occupancy sensor, the electrodes of which approach each other under the effect of weight and thus ensure a change in capacitance (see e.g. U.S. Pat. No. 8,896,326 B2, which also describes the evaluation principle for determining the magnitude of the impedance by means of I-Q demodulation, as is also advantageously used according to the disclosure). A further field of application of the method according to the disclosure is the detection of whether the driver is gripping the steering wheel. For this purpose, individual electrode surfaces are arranged in the steering wheel which, together with the vehicle chassis, form a capacitor whose dielectric is influenced by the hand, resulting in a change in capacitance.

### BRIEF DESCRIPTION OF DRAWINGS

FIG. 1 is a block diagram of a first example of a circuit for impedance measurement.

FIG. 2 is a block diagram of a second example of a circuit for impedance measurement.

FIG. 3 is a block diagram of a third example of a circuit for impedance measurement.

FIG. 4 is a block diagram of a fourth example of a circuit for impedance measurement.

FIG. 5 is a block diagram of a fifth example of a circuit for impedance measurement.

FIG. 6 is a block diagram of a sixth example of a circuit for impedance measurement.

### DESCRIPTION

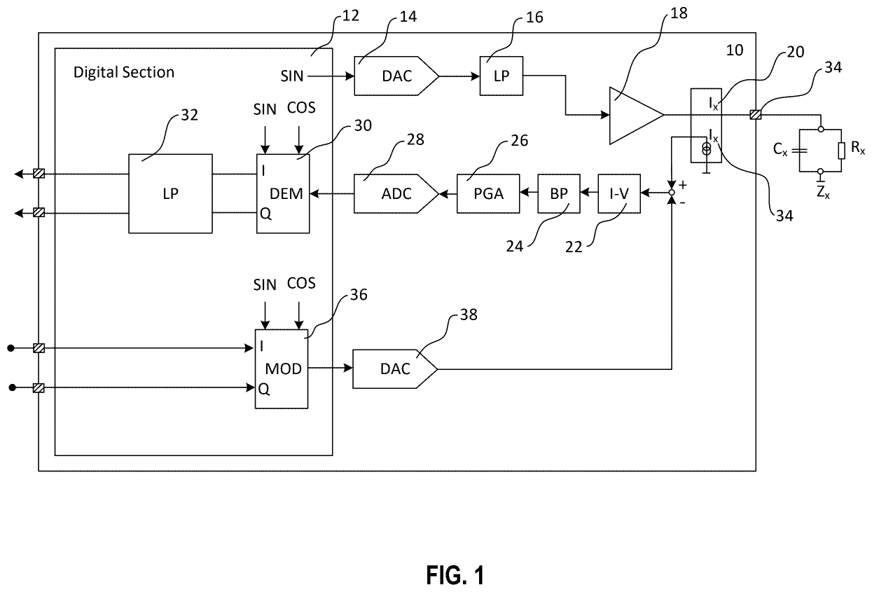

FIG. 1 shows the block diagram of a circuit 10 of a first example of the disclosure. An impedance ZX to be measured is excited by means of a sinusoidal voltage signal that is generated in a digital section 12 of the circuit 10. By means of a DAC 14, the digital sinusoidal signal is converted into an analog sinusoidal signal and, after low-pass filtering in a low-pass filter 16, is fed by a driver 18 to the impedance ZX to be measured. In response to this, a current IX is induced in the impedance ZX, which is mirrored in a current mirror 20. After a current-to-voltage conversion in an I-V converter 22 (e.g. shunt resistor) and band-pass filtering in a band-pass filter 24, the mirrored current IX is fed to an amplifier 26, whose output signal is converted into a digital signal by means of an ADC 28 for processing in the digital section 12. In the digital part 12, an I-Q demodulation is performed in an I-Q demodulator 30 to determine the real part and the imaginary part of the complex induced current IX. After further filtering in a digital filter 32, two signals are then present which are representative of the magnitude of the impedance ZX and can be further processed, for example, externally by the circuit 10.

Due to interference suppression measures for EMC protection, for example, the input 34 of the typically integrated circuit 10, to which the impedance ZX to be measured is connected, is connected with a comparatively large capacitance in relation to the impedance ZX to be measured. This results in offsets in the measurement signal, which should be compensated for in order to be able to measure with high resolution using comparatively simple means. A compensation current is therefore subtracted from the mirrored current IX, which thus compensates for the offset. As a result of this compensation, very small signals remain which, after amplification with an ADC 28 with a limited number of bits and limited input voltage, can still be converted into a digital signal with a sufficiently high resolution and further processed in the digital section 12. The compensation current is generated in the digital section 12 and subjected to I-Q modulation in an I-Q modulator 36 and then converted into the analog compensation current by a DAC 38.

Circuit 10 operates intermittently and at intervals. The measured value for the measured current in the digital section 12 determined in one of these intervals can be used to operate the I-Q modulator 36 for generating the digital compensation current using the parameters of the I-Q demodulator 30.

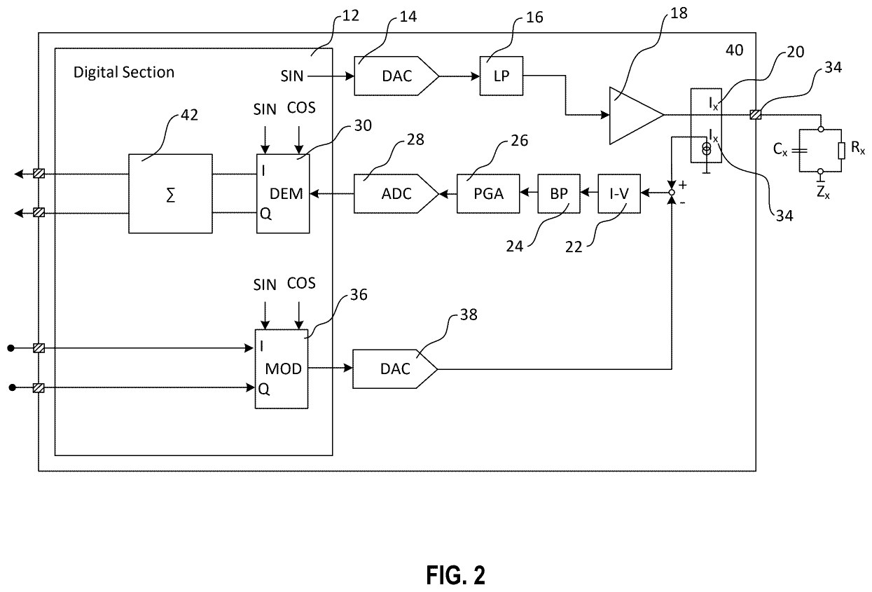

FIG. 2 shows a second variant of a circuit 40 for measuring an impedance ZX.

Insofar as the individual components of the circuit 40 correspond to or are similar to those of the circuit 10 of FIG. 1, they are indicated in FIG. 2 by the same reference signs as in FIG. 1.

The difference between the circuit 40 according to FIG. 2 and that according to FIG. 1 is the integration of the I and Q signal components at the output of the I-Q demodulator 30 by a (delta) integrator 42, which integrates both the I signal components and the Q signal components. The output signals of the integrator 42 are fed to the I-Q modulator 36 to generate the digital compensation current, which is converted via the DAC 38 into the analog compensation current, which in turn is subtracted from the measuring current IX. The function for the I output of the I-Q modulator is as follows:

$$I = - sin ( ω t ) {I}_{\sum }$$

The following equation results for the Q output of the I-Q modulator:

$$Q = - cos ( ω t ) {Q}_{\sum }$$

Here, I_{Σ}, Q_{Σ} are the outputs of the delta integrator 42.

If the impedance ZX no longer changes from interval to interval, the demodulator 36 no longer emits any signals (zero signal), which means that the impedance value last calculated by the integrator 42 continues to apply. If the impedance value changes, the output signals of the demodulator 36 deviate from zero. This changes the integrator output 42 and thus also the compensation current, which is subtracted from the measuring current IX in the next measuring interval. If the impedance ZX has not changed in the meantime, zero signals are generated again at the output of demodulator 36.

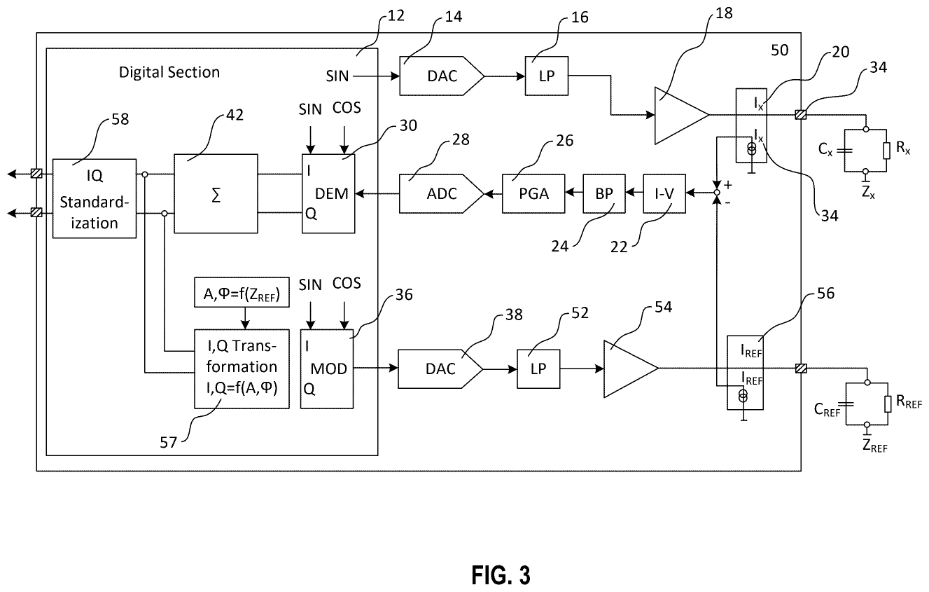

A further variant of a circuit 50 for measuring a potentially changing impedance ZX during operation is shown in FIG. 3. Here too, those components of the circuit 50 which are the same as or correspond to those of the circuit 10 in FIG. 2 are indicated in FIG. 3 by the same reference signs as in FIG. 2.

In the example shown in FIG. 3, a reference impedance ZREF is excited to generate the compensation current and its induced current IREF is used. For this purpose, a digital compensation voltage is generated in the digital section 12 by means of the I-Q modulator 36, which is applied to the reference impedance ZREF by means of a driver 54 after a DAC conversion in the DAC 38 and, if necessary, filtering in a low-pass filter 52.

The induced current IREF is mirrored by a current mirror 56 and subtracted from the mirrored measuring current IX in a known manner.

In the digital section 12, the I and Q signal components of the I-Q demodulator 30 are again integrated, whereby the output signals of the integrator 42 are subjected to an I-Q transformation in a circuit 50. The reason for this is that the outputs of the delta integrator for the I and Q signal components of the I-Q demodulator 30 may have to be swapped, depending on whether the reference impedance ZREF consists only of a capacitor or a resistor. If ZREF were only realized with the aid of a capacitor, then the I output of the delta integrator 42 would have to be connected to the inverted Q input of the I-Q modulator 36 and the Q output of the delta integrator to the I input of the I-Q modulator 36. If ZREF consisted solely of a resistor, the I output of the delta integrator 42 would have to be connected to the I input of the I-Q modulator 36 and the Q output of the delta integrator 42 to the Q input of the I-Q modulator 36, similar to FIG. 2. For “mixed cases” in which ZREF has both an imaginary, e.g. capacitive component and a real, e.g. resistive component, a transformation is therefore performed so that changes in the capacitance and resistance of the impedance ZX to be measured also only change the imaginary component (Q component) or only the real component (I component) of the I-Q demodulator 30 in the measurement result, the compensator must be phase-neutral. For this purpose, the I-Q transformation circuit 57 is used to rotate the phase shift due to ZREF, resulting in a total of −180°. The Transformation function for the I output of the I-Q modulator is as follows:

$$I = - A sin ( ω t ) [ {I}_{\sum } cos ( φ ) + {Q}_{\sum } sin ( φ ) ]$$

The following equation results for the Q output of the I-Q modulator:

$$I = - A sin ( ω t ) [ {I}_{\sum } cos ( φ ) + {Q}_{\sum } sin ( φ ) ] .$$

Here, I_{Σ}, Q_{Σ} are the outputs of the delta integrator. The phase φ generates the phase shift that is beneficial to achieve phase neutrality due to ZREF:

$$φ = a tan ( \frac{2 π {f}_{Si} {C}_{Ref}}{1 / {R}_{Ref}} )$$

The result for the amplitude A is:

$$A = \frac{0.5 / {R}_{Norm}}{\sqrt{1 / {R}_{Ref}^{2} + {( ω {C}_{Ref} )}^{2}}}$$

The parameter RNORM is used to perform an I-Q normalization. This has the effect that if the capacitance CX of the impedance ZX to be measured is equal to the normalization parameter RNORM=1/ωCX (or the resistance RX of the impedance ZX to be measured is equal to the parameter RNORM=RX), the measurement result of the imaginary or real part becomes one. This amplitude normalization can be performed using the I-Q transformation or it can be performed outside the control loop at the output of the delta integrator 42, as shown in FIG. 3 at 58.

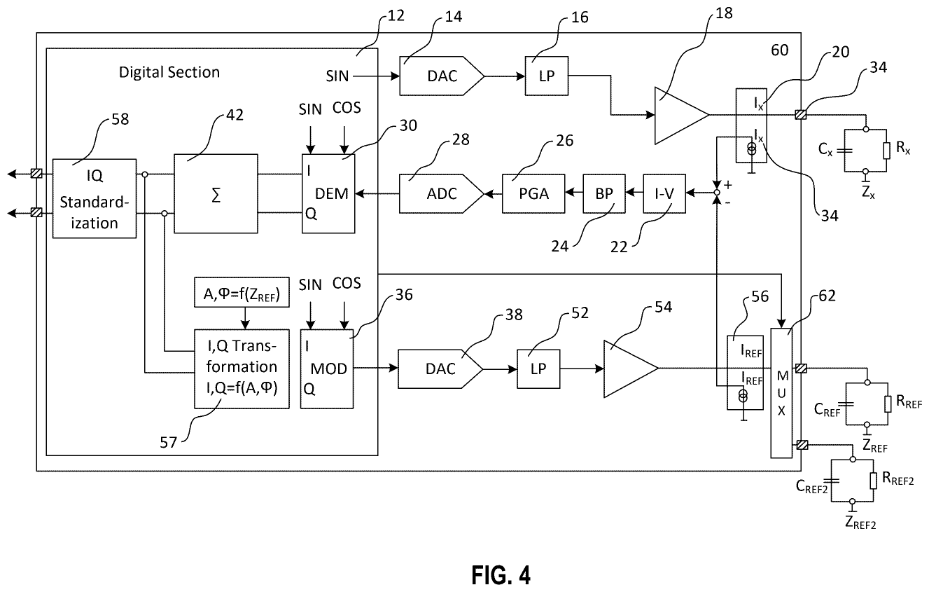

A further example of a circuit 60 for measuring an impedance ZX is shown in FIG. 4. Again, it applies that the individual components of the circuit 60, insofar as they correspond to or are the same as those of the circuit 50, are designated in FIG. 4 with the same reference numerals as in FIG. 3.

The difference between the circuit 60 and that shown in FIG. 3 is that the reference impedance can be switched to different reference impedances ZREF1 and ZREF2. It is also possible to choose between several discrete reference impedances. Switching takes place with the aid of a multiplexer 62, which receives a control signal from the digital section 12 and switches the compensation voltage to the selected one of the several reference impedances ZREF1, ZREF2, . . . . The induced compensation current IREF is fed to a current mirror via the same multiplexer 62 or another multiplexer (not shown). The sequence then behaves as shown in FIG. 3.

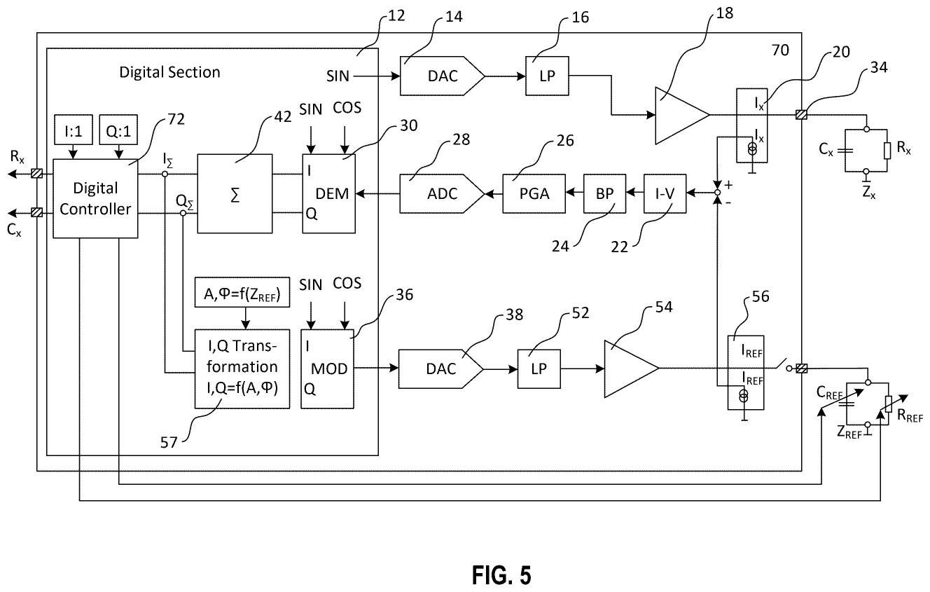

A last example of a circuit 70 for measuring an impedance ZX is shown in FIG. 5. Again, it applies that the individual components of the circuit 70, insofar as they correspond to or are the same as those of the circuit 60, are designated in FIG. 5 with the same reference numerals as in FIG. 4.

In contrast to the circuit 60 in FIG. 4, the circuit 70 in FIG. 5 does not switch to different discrete impedance references but rather uses a reference impedance ZREF whose capacitance CREF and whose resistance RREF are virtually infinitely variable. The control signals come from digital section 12. The digital controller 72 then outputs the value corresponding to RX as the I component and the value corresponding to ZX as the Q component. This means that RX=RREF and CX=CREF. However, if CX can be greater than the maximum value that can be set for CREF and RX greater than the maximum value that can be set for RREF, the specifications for the digital controller 72 would have to be less than 1, e.g. 0.1, which means that the output of the digital controller 72 would then output an I component and a Q component that are each 1/10 of the set value for CREF or RREF, i.e. RX and CX of the impedance ZX to be measured are greater by a factor of 10 than output by the digital controller 72. This reference impedance ZREF, realized for example as a capacitance and resistance decade, is set with the aid of a higher-level control loop so that the I,Q output of the delta integrator 42 assumes the value one in the steady state. The measured value of the unknown impedance ZX is then represented by the setting of the ZREF decade. The advantage of the sensor architectures shown in FIGS. 2 to 4 is that non-linearities in the signal chain (I-V converter 22, bandpass filter 24, amplifier 26, ADC 28) have no influence on the measurement accuracy. The sensor shown in FIG. 5 is also insensitive to non-linearities in the signal and reference path (DAC 14, DAC 38, current mirror 20, current mirror 56). The measuring accuracy is only determined by the ZREF decade.

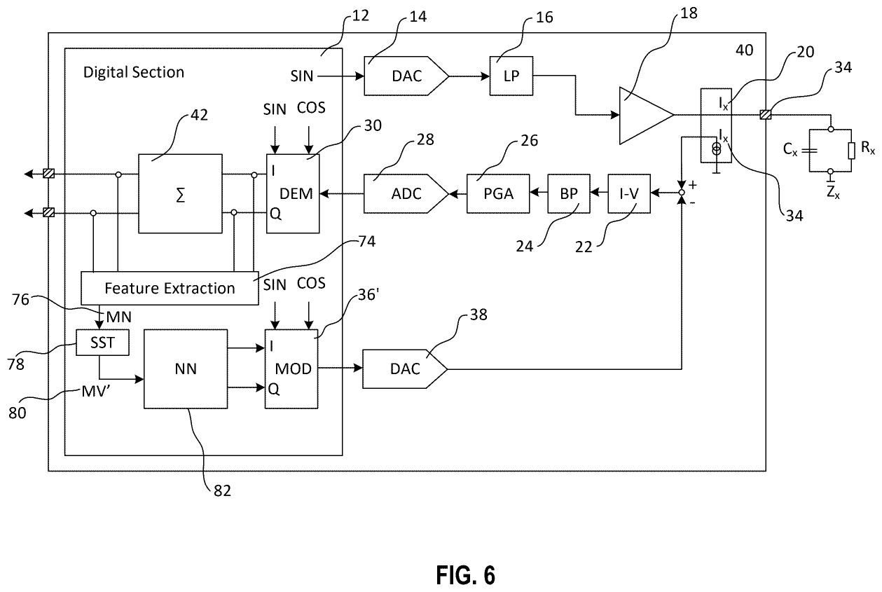

Finally, a sixth example of the disclosure is described with reference to FIG. 6. This example differs from the other examples in that computer-implemented elements of artificial intelligence on hardware and software elements of artificial intelligence are preferably used to generate the offset signal (compensation current).

As in the example of FIG. 2, the signal at the output of the delta integrator is fed to the I-Q modulator 36′, but with intermediate processing by means of feature extraction 74, in which the I-Q data at the output of the demodulator 30 and the signals after processing in the delta integrator 42 are included. The resulting feature vector 76 is passed to a significance enhancement stage 78, resulting in a modified feature vector 80, which is fed to a preferably computer-implemented neural network 82, the structure of which is arbitrary and corresponds to the typically known neural networks. The significance enhancement stage 78 may, for example, be formed by a processor of the apparatus which, inter alia, executes a computer-implemented procedure for enhancing the significance of the feature vector 76 to generate, for example, the modified feature vector 80. The I and Q data for the I-Q modulator 36′ are then output at the output of the neural network 82, the output signal of which specifies the compensation current after conversion into an analog signal in the DAC 38.

The feature extraction provided in this example thus captures the I and Q data of the demodulator and the output signal after processing in the delta integrator 42 and generates the feature vector MV (see reference numeral 76).

Information on feature vectors can be found, for example, at https://de.wikipedia.org/wiki/Merkmalsvektor.

For each dimension of the characteristic vector, there is a permissible value range with a specific size. A significance boosting step SST (see reference numeral 78) now distorts the feature vector so that in each dimension 50% of the training values are above the threshold of half the value range and 50% below the threshold of half the value range, but preferably still within the permissible value range for the respective dimension (these are exemplary values). The significance increment stage 78 generates a mapping corresponding to a matrix polynomial. To form the nth summand of the polynomial, a distortion matrix Xn with n instances of the feature vector MV is formed by matrix-vector multiplication X*MVn and added over all summands of the polynomial.

Other methods of clustering are possible. The significance enhancement stage can increase the significance of a feature vector based on training data in one of the following exemplary different ways:

### Feature Engineering

By extracting values of new features (feature engineering), the significance enhancement stage can extract relevant information from the existing features of the feature vector MV and add it to the feature vector MV in the form of new dimensions. This can increase the significance of the feature vector.

### Feature Selection

Instead of using available features of the feature vector, the dimensionality of the feature vector can be reduced again by feature selection depending on the feature vector in order to select those features that have the greatest relevance for the current pattern recognition task.

Significance enhancement can, for example, use computer-implemented machine learning methods that apply regularization techniques such as L1 and L2 regularization to influence the weighting of features and control the significance of certain features.

### Ensemble Method

Significance enhancement can use ensemble methods such as random forests or gradient boosting to increase the significance of feature vectors by combining multiple models and selecting the best features.

### Domain Knowledge

The incorporation of domain knowledge of the application situation of the device and the implementation of corresponding computer-implemented procedures in the significance enhancement can contribute to increasing the significance of feature vectors MV′ (see reference sign numeral 80) by incorporating relevant information into the model. This can be achieved through manual adjustments or the use of pre-trained models with domain knowledge.

The neural network NN (see reference sign 82) evaluates the respective feature vector with increased selectivity.

The aforementioned explanations on feature extraction and significance enhancement are not limited to the example of FIG. 6.

### LIST OF REFERENCE SYMBOLS

10 circuit
12 digital section
14 DAC
16 low-pass filter
18 driver
20 current mirror
22 I-V converter
24 bandpass filter
26 amplifier
28 ADC
30 I-Q demodulator
32 digital filter
34 input
36 I-Q modulator
36′ I-Q modulator
38 DAC
40 circuit
42 delta integrator
50 circuit
52 low-pass filter
54 driver
56 current mirror
57 I-Q transformation circuit
58 I-Q standardization circuit
60 circuit
62 multiplexer
70 circuit
72 digital controller
74 feature extraction
76 feature vector
78 significance enhancement stage
80 feature vector with enhanced significance
82 neural network
Z_{REF1} reference impedance
Z_{REF2} reference impedance
Z_{X} impedance to be measured
I_{X} measuring current
I_{REF} reference current

What is claimed is:

1. A method for determining, at multiple intervals and thus repeatedly, an electrical signal characteristic of a magnitude of and/or a change in an impedance which changes under influence of a magnetic, electric, and/or electromagnetic field, wherein the magnetic, electric, and/or electromagnetic field for its part changes due to an object approaching the impedance, the method comprising:
performing measurements at least in one group of measurement intervals, which has one or more consecutive measurement intervals, and at least one compensation interval positioned chronologically before the at least one group of measurement intervals or before each group of measurement intervals;
per measurement interval:
applying a sinusoidal excitation voltage to the impedance; and
inducing a measuring current in the impedance as a result of the sinusoidal excitation voltage;
using the measurement current of a measurement interval as a compensation current for at least one subsequent measurement interval by subtracting a compensation current in the at least one subsequent measurement interval from the measurement current of the measurement interval to generate an analog evaluation current signal;
using the generated analog evaluation current as a signal characteristic of a magnitude and/or a change in the impedance due to an object approaching the impedance.

2. The method according to claim 1, further comprising, upon determining the compensation current, generating a compensation signal during the at least one measuring interval, by a signal generating unit to be subtracted from the measuring current of the at least one measuring interval.

3. The method according to claim 1, further comprising amplifying the analog evaluation current signal, wherein the amplified analog evaluation current signal is a signal characteristic of the magnitude and/or the change in impedance.

4. The method according to claim 1, further comprising:
providing a first compensation current for an initial state;
performing, as a part of the one group of measurement intervals, a first set of measurement intervals chronologically preceding a first compensation interval; and
generating the compensation current during the first set of measurement intervals based on the first compensation current.

5. The method according to claim 1, wherein generating the compensation current further includes
applying a neural network of any type and any structure and/or
applying a Hidden Markov Model and/or
applying a Petri net and/or automatic learning for generating knowledge from past and previous experiences, such as machine learning, deep learning and/or a processing of predictors, i.e., predictive variables from events registered in the past.

6. The method according to claim 1, further comprising:
converting, by an analog-to-digital converter, the analog evaluation current signal;
demodulating the converted analog evaluation current signal, by an I-Q demodulation;
determining an I signal component and/or a Q signal component from the demodulated evaluation current signal; and
using the I signal component and/or the Q signal component as the signal characteristic of the magnitude and/or the change in impedance.

7. The method according to claim 6, further comprising digitally generating parameters of the I-Q demodulation in the at least one compensation interval.

8. The method according to claim 1, further comprising selecting at least one of a resistive, an inductive and a capacitive impedance as the impedance, wherein the capacitive impedance is designed as a capacitor with dielectric or as an electrode surface.

9. A method for determining, at multiple intervals and thus repeatedly, an electrical signal characteristic of a magnitude of and/or a change in an impedance which changes under influence of a magnetic, electric and/or electromagnetic field, wherein the magnetic, electric and/or electromagnetic field for its part changes due to an object approaching the impedance, comprising:
per interval
applying, a sinusoidal excitation voltage to the impedance;
inducing a measuring current in the impedance as a result of the excitation voltage;
feeding a difference between the measuring current and a compensation current to an input of an analog or digital integrator, an_output of which supplies the compensation current after digital-to-analog conversion, if necessary; and
forming a signal characteristic of the magnitude and/or change in impedance based on the output of the integrator.

10. The method according to claim 9, further comprising:
amplifying a difference signal from a difference between the measuring current and the compensation current;
performing an analog-to-digital conversion on the amplified difference signal to generate a converted difference signal;
feeding the converted difference signal to a digital I-Q demodulator;
feeding I and Q signal components of the digital I-Q demodulator to an input of a digital integrator;
integrating the I and Q signal components over time to form the compensation current;
modulating an output of the I-Q demodulator a digital I-Q modulator; and
applying an output of the digital I-Q modulator to a digital-to-analog converter, thereby outputting the compensation current.

11. A method for determining, at multiple intervals and thus repeatedly, an electrical signal characteristic of a_magnitude of and/or a change in an impedance which changes under influence of a magnetic, electric and/or electromagnetic field, wherein the magnetic, and/or electromagnetic field for its part changes due to an object approaching the impedance, comprising:
per interval
applying a sinusoidal excitation voltage to the impedance;
inducing a measuring current in the impedance as a result of the sinusoidal excitation voltage;
applying a compensation voltage that is 180° out of phase with the sinusoidal excitation voltage to a reference impedance of known magnitude;
inducing a compensation current in the reference impedance as a result of the compensation voltage,
feeding a difference signal between the measuring current and the compensation current, possibly after amplification, to an input of an analog or digital integrator;
providing a magnitude of the compensation current possibly after digital-to-analog conversion based on the integrated difference signal;
generating the compensation voltage; and
outputting, from the integrator, a signal characteristic of the magnitude and/or the change in impedance.

12. The method according to claim 11, wherein applying the compensation voltage to the reference impedance further comprises selecting from a plurality of reference impedances each having a known magnitude, applying the reference voltage to one of the selected reference impedances, and supplying the compensation current as a result of applying the reference voltage to the selected reference impedance.

13. The method according to claim 11, wherein a magnitude of the reference impedance is variably adjustable and is varied by a controller having an input and an output, the input of the controller receiving the signal at the output of the integrator, and the output of the controller providing the signal characteristic of the magnitude and/or variation of the impedance.

14. The method according to claim 11, wherein the difference signal between the measuring current and the compensation current is subjected to an analog-to-digital conversion to generate a converted difference signal, and the converted difference signal is then fed to a digital I-Q demodulator, wherein I and Q signal components of the converted difference signal generated by the digital I-Q demodulator are fed to an input of a digital integrator, and further wherein, to form the compensation voltage, the I and Q signal components integrated over time are modulated in a digital I-Q modulator, the output of the digital I-Q modulator being connected to a digital-to-analog converter that outputs the compensation current.

15. The method according to claim 11, wherein the difference signal between the measuring current and the compensation current is subjected to an analog-to-digital conversion to generate a converted difference signal, and the converted difference signal is then fed to a digital I-Q demodulator, wherein I and Q signal components of the converted difference signal generated by the digital I-Q demodulator are fed to an input of a digital integrator, and further wherein, to form the compensation voltage, the I and Q signal components integrated overtime are modulated in a digital I-Q modulator whose output is connected to a digital-to-analog converter that outputs the compensation current, and I and Q portions of the reference impedance are adjusted according to control specifications for I and Q portions in a superimposed control loop with digital control in dependence on the I and Q signal components integrated over time output by the digital integrator.

16. A method for determining, at multiple intervals and thus repeatedly, an electrical signal characteristic of a magnitude of and/or a change in an impedance which changes under influence of a magnetic, electric and/or electromagnetic field, wherein the magnetic, and/or electromagnetic field for its part changes due to an object approaching the impedance, the method comprising:
per interval
applying a sinusoidal excitation voltage to the impedance;
inducing a measuring current in the impedance as a result of applying the excitation voltage;
calculating a compensation current based on the measuring current or a variable derived therefrom by:
a neural network of any type and any structure and/or
a Hidden Markov Model and/or
a Petri net and/or automatic learning of any kind for generating knowledge from past and previous experiences, such as machine learning, deep learning and/or processing of predictive variables from events registered in the past, and
a difference between the measuring current and the compensation current forms a signal characteristic of a magnitude and/or change in impedance.
